(19) United States
(12) Patent Application Publication
(10) Pub. No.: US 2012/0237041 A1
(43) Pub. Date: Sep. 20, 2012

(54) Method And An Apparatus For Deriving Information From An Audio Track And Determining Similarity Between Audio Tracks

(75) Inventor: Tim Pohle, Linz (DE)

(73) Assignee: JOHANNES KEPLER UNIVERSITÄT LINZ, Linz (AT)

(21) Appl. No.: 13/384,548

(22) PCT Filed: Jul. 23, 2010
(86) PCT No.: PCT/EP10/60725

§ 371 Date: May 31, 2012

Related U.S. Application Data
(60) Provisional application No. 61/213,884, filed on Jul. 24, 2009.

(51) Int. Cl. H04R 29/00; G06F 17/00

(52) U.S. Cl. 381/56; 700/94

(57) ABSTRACT

A method of deriving information from an audio track, or a part thereof, wherein onsets or intensity/amplitude variations are detected as well as at which frequencies (timbral frequencies) or in which frequency bands these occur. Especially interesting is the frequency of such onsets. In this manner, the frequency of beats of a low frequency drum may be separated from that of onsets of a higher frequency drum or guitar of other instrument, and these frequencies provide important information about the track, such as genre, beat, etc. Naturally, parameters may be provided relating to the individual frequencies (frequency of onsets and frequency/tone of the sound of the onsets), or a fit thereto may be used to reduce the number of parameters. It is noted that the frequencies in which the onsets are determined may be tones or half tones in the relevant scale. As onsets of instruments normally are whole multiples of a basic frequency or beat, it has been found advantageous to represent the individual frequencies on a logarithmic scale so that such multiples of frequencies are equidistant and so that transposing to higher or lower beats is very easy.

The present invention relates to a novel manner of deriving information from audio tracks and in particular to a method wherein the frequencies of onsets or amplitude variations in different Umbral frequencies is used for characterizing an audio track.

Methods of this type may be seen in:
Shi, Yuan-Yuan et al., LSAS 2006, Log-scale Modulation Frequency Coefficient: A Tempo Feature for Music Emotion Classification,
Schuller, B. et al, Tango or Waltz, “Putting Ballroom Dance Style into Tempo Detection”, EURASIP Journal on Audio, Speech, and Music Processing Volume 2008,
E. Pampalk et al., ISMIR 2003, “Exploring Music Collections by Browsing Different Views”,
Ellis, T., “Beat Tracking with Dynamic Programming, submission to the 3rd Annual Music Information Retrieval Evaluation Exchange”, 2006,
West, Kris, “Novel techniques for Audio Music Classification and Search”, School of Computing Sciences, University of East Anglia, September 2008,
Jensen, H. et al., “A Chroma-Based Tempo-Insensitive Distance Measure for Cover Song Identification”, submission to the 4th Annual Music Information Retrieval Evaluation Exchange, 2007,
Saito et al., “Specmurt Analysis of multi-pitch music signals . . . ”, Queen Mary University of London, 2005,
Holzapfel et al., “A Scale Transform based method . . . ”, IEEE, 2009,
US2007/0055500, US2005/0177372, W02009/001202, and US2007/0174274.

It has been found that the onsets of instruments (beating of a drum, onsets of guitar strings, clapping and the like) and especially when seen in multiple frequencies or nodes are quite useful for describing the audio track and for identifying similar tracks. A desire, however, is to provide this information in a manner wherein easy comparison to other tracks is possible.

In a first aspect, the invention relates to a method of deriving information from an audio track, the method comprising the steps of:

1. for each of a plurality of first frequencies or frequency bands, deriving from the track information relating to points in time, or one or more second frequencies, of occurrence of intensity/amplitude variations exceeding a predetermined value/percentage in the actual first frequency/band,

2. deriving the information relating to the track from the first frequencies/bands and the one or more points in time and/or one or more of the second frequencies relating to the first frequencies/bands,

wherein step 2 comprises representing the information as an at least one-dimensional representation along at least one axis, the points in time or second frequencies being represented along one of the axes on a non-linear scale.

In the present context, the information will relate to individual first frequencies/bands but may be represented in any manner, including as parameters each relating to more than one of the first frequencies/bands. Such manners are described further below.

In the present context, a track is any representation of e.g. audio, sound, music or the like. A track may be represented as analog or digital signals, such as by a LP record, a magnetic tape, a modulated, airborne signal, such as AM or FM radio signal, on a digital form, such as a file or a stream of digital values, such as packets or flits, as streamed wirelessly and/or over a network of any type. The full track may be available or only part of it may.

Presently, the first frequencies/bands relate to the frequency contents of the track. This may also be called the Umbral frequency but in general relate to the sound frequency/ies/bands in which the amplitude/intensity variations take place. Such frequencies may be well-defined in eg. Hertz or may be defined as e.g. tones in a scale. Also, it may be desired to define the frequencies/tones as bands, in that instruments etc. are expected to be in tune and may vary their frequencies in the course of the audio track. Frequency bands may be selected with any width, such as 2-50 Hz, and this width may vary with the frequency of the first frequency/band.

Presently, it is preferred to use first frequencies both below 250 Hz, where typically bass and drum instruments output sound, and above 250Hz, where other instruments output sound, as most instruments will provide onsets which are descriptive of the rhythm of the track. Thus, first frequencies in the interval of 250 Hz-1 kHz and 1-11 kHz may also be used.

Naturally, the present method may be performed on a full audio track or a part thereof. Depending on the first frequencies/bands, larger or smaller bits of the track will be required or desired. Thus, if a first frequency lower than 1 Hz is desired, a bit or snippet longer than 1 or 2 seconds is preferred. Also, to obtain a desired precision in the determination, it could be desired to ensure that the part or snippet of the audio track was more than 2, such as more than 4, preferably more than 10 times as long as the inverse of the frequency of the lowest of the first frequencies/bands.

Preferably, 4 or more, preferably 5, 10 or 20 or more first frequencies/bands are used. Further below, the desired selection of such first frequencies/bands is described.

In the present context, an intensity/amplitude variation may be an increase or decrease of the intensity/amplitude within the first frequency/band in question. To be relevant, this variation exceeds a predetermined value/percentage. This value or percentage may be determined in relation to a mean or historic value of the signal/intensity/amplitude. In one situation, the variation will be taken as a minimum variation or difference in relation to a mean value taken before the variation takes place, such as by providing a running mean, and identifying points in time where the value exceeds the present running mean added the predetermined value or percentage.

Additional demands may be put as to the steepness of the variation (increase/decrease over time), either as a steepness measure or a period of time over which the variation is allowed to progress to exceed the predetermined value/percentage.

Naturally, a percentage may be used as well as an amount of the signal, which usually is represented as a variation of a given value/intensity/amplitude/voltage/current or the like. Preferably a variation exceeding 10%, such as 20%, preferably exceeding 30%, such as 40%, preferably 50, 60, 70 or 80%, such as 100% or more is selected in order to reduce the influence of e.g. noise. A value may also be selected, and the preferred value/amount will then be set according to the scaling of the signal of the first frequency/band.

Alternatively, points in time where the value exceeds the value of a running mean may be used.

The points in time may be absolute, such as in relation to a predetermined clock, or may be relative, such as in relation to a given starting point in time. Relative points in time may be represented as second frequencies, if these are sufficiently periodic.

According to the invention, step 2 comprises representing the information as an at least one-dimensional representation along at least one axis, the points in time or second frequencies being represented along the axis on a non-linear scale.

This representation will comprise a number of values corresponding to the points in time or second frequencies and may be represented in any manner, such as as a number of discrete points/values along an axis, a vector, a fit or the like. A representation along a single axis may be by pairs of information being a second frequency or point in time as well as a value indicating the strength of the second frequency in question or a strength of the intensity/amplitude variation at the point in time in question.

The non-linear representation may be obtained in a number of manners. In one situation, a lower part of the second frequencies, such as below 2.5 Hz, (or lowest part of the points in time) are represented on a linear scale, and other parts on a logarithmic scale. In another situation, all frequencies/points in time are represented on a logarithmic scale.

Alternatively, the second frequencies or points in time, or at least a part thereof, may be represented on a square rooted scale.

When the second frequencies are represented along the second axis on a log scale, e.g. a doubling in frequency will be represented equidistantly—which is easier to “transpose” to higher/lower frequencies. Also, it will be simple to compare audio tracks of different tempi in that the overall rhythm beat (the basic beat and any off-beats or higher frequency beats) will be equidistantly shifted along that axis, if the rhythm is in general the same but merely shifted in tempo. It has been noted that a slight shift in tempo between two tracks still makes these very similar.

A square-rooted scale will bring about approximately the same effect.

Thus, the audio track may now be characterized by the onsets of instruments or other sound generators (hands, mouth or the like) in different frequencies/bands. The onsets/frequency of a low frequency drum (larger drum) such as a bass drum may be separated from and identified separately from that of a higher frequency drum (smaller drum), a high hat, a guitar string, a clap or the like. Thus, the beat as well as off-beat onsets may be determined and used for characterizing the audio track.

It is noted that even though the most preferred type of information sought for is the second frequencies, the points in time of such variations, which will then typically be for non-periodical variations, may also be used for characterizing the audio track. Such points in time may be compared between first frequencies/bands as relative points in time or relative time periods, and may be used for identifying for example deviations from periodicities in the track.

Preferably, the first frequencies or frequency bands are selected as tones or half tones of a predetermined scale. Even though most instruments do not generate a sound only within the desired frequency but also outside thereof, noise tends to be more steady in time and broad spectered and thus tends to be better reduced or removed than the desired or sought for signal. It is noted that scales differ in different parts of the world. One example is western pop music and Arabian type music. Naturally, this brings about a challenge, if it is desired to compare audio tracks based on different scales. On the other hand, such audio tracks normally also in other respects are so different that this gives little meaning. If such comparison or similarity determination is desired, scales may be combined and/or frequencies/bands from all or multiple scales may be used in the same analysis.

Alternatively, perceptually motivated scales, such as the Mel scale, may be used when selecting the first frequencies.

In a preferred embodiment, step 1 comprises removing, in each first frequency/band, parts of the track not having an intensity/amplitude variation exceeding the predetermined value/percentage. A usual way of removing such parts is to subtract a mean value of the signal surrounding the particular point in time. Thus, the signal, in each first frequency/band, may be analyzed by deriving a running/moving mean from the signal at points in time preceding or surrounding a point in time, and only if the signal at this point in time exceeds the predetermined value/percentage is the signal maintained, or the mean value may be subtracted therefrom. If not, the signal at that point in time is set to zero, in order to remove parts not forming the sought for onsets.

Having thus converted the signal at each first frequency/band, further analysis may be performed.

One type of analysis that may be performed both on the converted as well as the original signal at each first frequency or in each first band is one wherein step 1. comprises determining the one or more second frequencies by Fourier transforming a part of the track within the first frequency/band. Then, any periodicity of remaining variations in the signal, or simply in the signal, in the pertaining first frequency/band, will be visible as high-energy parts of the FFT spectrum. In this manner, one or more second frequencies will be easily determinable.

It should be noted that a periodicity of peaks or variations may be determined even though some peaks/onsets are missing in the overall periodicity. This may be due to other breaks or the like in the audio track, due to noise covering or hiding the peak/variation, or due to (normally a live recording) this particular peak/variation simply being lower in intensity/amplitude.

In this connection, it is noted that the FFT could be replaced by other time-frequency transforms, such as he Discrete Cosine Transform (DCT) or the Discrete Hartley Transform (DHT). In addition, filterbanks with subsequent intensity measurement could be used.

Before performing the FFT transformation, it may be desired to “clean up” the signal in order to obtain a better FFT transformation. For example, sharp edges at the ends of the part of the signal may generate interfering frequencies in the FFT. To avoid this, preferably, the part of the track within the first frequency band is firstly filtered with a Hanning window and zero padded outside the window, before the FFT is performed.

Naturally, the FFT and above conversion of the signal in the first frequency/band may be performed for the full track or once for a single part of the track, or may be performed for a number of, such as consecutive and potentially overlapping, parts of the track. Such parts may have a duration of e.g. 1-10 seconds, such as 1-5 seconds, preferably 2-3 seconds.

In one preferred embodiment, step 2. comprises deriving the representation of the information as an at least two-dimensional representation having along a second axis the first frequencies/bands.

Then, step 2. could comprise the steps of:
fitting/applying a two-dimensional curve/transformation to the representation of the derived information as a coordinate system having a third axis relating to a strength of the second frequencies or of the intensity/amplitude variations at the pertaining points in time and in the first frequencies/bands and
deriving the information as parameters of the applied/fitted curve/transformation.

In another preferred embodiment, step 2. comprises the steps of:
fitting/applying an at least one-dimensional curve/transformation to the representation of the derived information in a coordinate system having a second axis of the coordinate system relating to a strength of the second frequency or of the intensity/amplitude variations at the pertaining points in time and
deriving the information as parameters of the applied/fitted curve/transformation.

As mentioned above, these embodiments illustrate two manners of representing the information. Thus, the second frequencies identified or derived may be represented in the representations as an intensity/value/grey scale or the like, and the periodicity or strength, such as if derived using the above FFT, may be used to not only identify a second frequency but also the strength thereof.

In this manner, the potentially complex 1D or 2D representations may be replaced/fitted with a curve describable with less parameters. One advantage of this is that a slight shift in e.g. a second frequency will not have a big impact, which corresponds to the fact that two tracks with almost the same rhythm normally would be assumed to be similar to each other.

In one situation, the 1D or 2D curve is a cosine and the applying step is that of a 1D or 2D discrete cosine transformation.

This 1D or 2D curve/transformation may be provided once for the whole track or a part of the track analyzed or may be provided for each of a number of individually analyzed parts of the track. Subsequently, if more curves/transformations are derived for one track, these are combined into a single representation, such as by providing a mean value.

A second aspect of the invention relates to a method of estimating a similarity between a first and a second audio track, the method comprising the steps of:
deriving, from each track, information as derived by the method according to the first aspect,
performing a determination of the similarity from a similarity between the derived information.

In the present context, a similarity between two audio tracks may be a similarity based on a number of parameters. Presently, this similarity focuses on rhythm and/or amplitude/intensity variations within predetermined frequencies/bands or Umbral frequencies in the tracks.

Thus, the similarity is determined from the information derived by the first aspect, as this information describes this type of content in the tracks.

Naturally, this type of similarity may be determined, also on the basis of the information provided by the first aspect, in a number of manners. In one situation, this will depend on the actual contents of or representation of the information provided by the first aspect.

In one embodiment, the determination step comprises determining a Kullback-Leibler divergence between the information derived from the first and second audio tracks. The KL is one of the most successful similarity divergences. Another interesting divergence is the Jensen-Shannon divergence

Alternatively, or in addition, the determination step could comprise representing the derived information as vectors and determining the similarity from a distance between the vectors. This could be the Euclidian distance.

When the information is represented as the above representation having along one axis the points in time or second frequencies, where the second frequencies are represented along the axis on a log scale, this representation automatically facilitates easy identification of tracks with the same rhythm but slightly different tempi. Such tracks will have similar representations, one being shifted slightly along the second frequency axis.

In this respect, the representation on the non-linear scale may aid in determining similarity especially of tracks with similar rhythms but which are shifted in speed or beat. In this manner, when representing the higher frequencies/points in time relatively closer to each other (than it would be when frequencies are represented on a linear scale) than the lower frequencies/points in time, this shifting in beat/speed will be less visible in the representation of the higher frequencies, as the shift will affect the representation of the various frequencies more similarly. This effect may be obtained when using e.g. a logarithmic representation. In addition,the representations or their fits/transformations may slightly blur the representation (due to the fitting process), whereby closely corresponding representations may have closely corresponding fits.

Also, a translation may be performed along the axis representing the second frequencies in order to determine a position in which the two representations or fits correspond the best, and subsequently determine similarity between such translated representations/fits. Naturally, the distance translated may be taken into account when determining the similarity. In addition to this translation along the axis representing the second frequencies, a translation may also be performed along the axis representing the first frequencies. Also the distance of translation along this direction may be taken into account when determining the similarity.

A third aspect of the invention relates to an apparatus for deriving information from an audio track, the apparatus comprising:

1. first means for, for each of a plurality of first frequencies or frequency bands, deriving from the track information relating to points in time or one or more second frequencies of occurrence of intensity/amplitude variations exceeding a predetermined value/percentage in the actual first frequency/band,

2. second means for deriving the information relating to the track from the first frequencies/bands and the one or more points in time and/or one or more of the second frequencies relating to the first frequencies/bands

wherein the second means are adapted to derive a representation of the information in an at least one-dimensional representation having along one axis the points in time or second frequencies on a non-linear scale.

Depending on the nature of the track, the deriving means may be able to read or access an analogue signal and/or a digital signal which may be streamed or accessed as a complete or part of a file, packet or the like. Thus, the deriving means may comprise an antenna or other means for receiving wireless communication, signals or data, means for receiving wired communication, signals or data, and/or means for accessing a storage holding analogue or digital signals, communication or data.

In this regard, the apparatus naturally may be any type of apparatus adapted to perform this type of determination, typically an apparatus comprising one or more processors, hard wired, software controlled or any combination thereof, such as a DSP.

The apparatus may have access to the track either from a storage internal to the apparatus or external thereof, such as available via a network, wireless or not, such as LAN, WAN, WWW or the like. Naturally, if only part of the track is analyzed, only this part of the track need be available to the apparatus, and in the extreme case, only the information of the (full or a part of the) track within the first frequencies/bands need be available.

The first and second means may be formed by two individual means or one and the same means, such as a processor.

In one embodiment, the first means are adapted to select the first frequencies or frequency bands as tones or half tones of a predetermined scale. As mentioned above, such scales may vary between different types of music but may for the use in the present analysis be combined.

In another embodiment, the first means are adapted to remove, in each first frequency/band, parts of the track not having an intensity/amplitude variation exceeding the predetermined value/percentage.

Preferably, the first means are adapted to determine the one or more second frequencies by Fourier transforming a part of the track within the first frequency/band. Then, the first means may be adapted to firstly first filter the part of the track within the first frequency band with a Hanning window and zero padded outside the window. As mentioned above, the whole track, one part of the track, or a number of parts of the track may be analyzed.

In one embodiment, the second means are adapted to derive the representation of the information as an at least two-dimensional representation having along a second axis the first frequencies/bands.

Then, the second means could be adapted to:
apply/fit an at least two-dimensional curve/transformation to the representation of the derived information in a coordinate system having a second axis of the coordinate system relating to a strength of the second frequency or of the intensity/amplitude variations at the pertaining points in time, a third axis relating to the first frequencies/bands, and
derive the information as parameters of the applied/fitted curve/transformation.

Alternatively or in addition, the second means could be adapted to:
apply/fit an at least one-dimensional curve/transformation to the representation of the derived information in a coordinate system having a second axis of the coordinate system relating to a strength of the second frequency or of the intensity/amplitude variations at the pertaining points in time and
derive the information as parameters of the applied/fitted curve/transformation.

A fourth aspect of the invention relates to an apparatus for estimating a similarity between a first and a second audio track, the apparatus comprising:
an apparatus according to the third aspect,
means for receiving the derived information from the apparatus and relating to both the first and the second tracks and for performing a determination of the similarity from a similarity between the derived information.

Naturally, the first and/or second means of the apparatus according to the third aspect may also form the means of the fourth aspect. Thus, one or more processors may be used for providing the desired information.

Normally, the process is started by a user hearing a track and wishing to know of similar tracks. Thus, the apparatus may have means for a user to identify one of the first and second tracks, such as by the user pushing a button, activating a touch screen, rotatable wheel or the like, including the use of voice commands and/or a camera.

The information relating to the individual tracks may be stored remotely and centrally for a number of apparatus according to the fourth aspect which then need not the capability of analyzing a track but merely that of availing itself of the information relating to a number of tracks and then determining the similarity. In that manner, the actual analyzing capability need not be widely spread.

As mentioned above, the non-linear representation may be used during the similarity determination to render less relevant differences between higher frequencies or points in time less visible or relevant, such as by “compressing” the axis at such higher values, as would effectively be the situation if a logarithmic representation was used (or a square-rooted, for example).

Thus, a fifth aspect of the invention relates to an apparatus for estimating a similarity between a first and a second audio track, the apparatus comprising:
means for accessing information derived according to the first aspect, for each track,
means for receiving the derived information and for performing a determination of the similarity from a similarity between the derived information.

Then, the accessing means may be adapted to access the information over a network (wireless or not), such as LAN, WAN, WWW or the like. Also, the access may be over the telephone network or may be to/from a local storage available to the apparatus.

In any of the fourth and fifth aspects, the means may be adapted to determine a Kullback-Leibler divergence between the information derived/accessed from the first and second audio tracks. Alternatively or in addition, the Jensen-Shannon divergence may be used, and/or the means may be adapted to represent the derived information as vectors and determine the similarity from a distance, such as the Euclidian distance, between the vectors.

A sixth aspect of the invention relates to a data storage comprising a plurality of groups of information each group of information relating to an audio track and to one or more second frequencies of amplitude/intensity variations exceeding a predetermined value/percentage within one or more first frequencies/frequency bands of the pertaining audio track, the information being represented as an at least one-dimensional representation along at least one axis, the points in time or second frequencies being represented along one of the axes on a non-linear scale.

In the present context, data may be stored on a single data storing element or a multiple of such elements. Naturally, all such elements are available to a method or apparatus requiring such access. If multiple storing elements are used, these need not be positioned in the vicinity of each other. In one example, each record label may provide the information relating to all tracks produced by that label, and anybody wishing to access such information may do so over e.g. the WWW.

It may be desired that the information relating to all tracks is represented in the same manner, but this is not required. In relation to the first aspect of the invention, the points in time and/or second frequencies may, once the first frequencies/bands have been defined, define the track. These points in time/second frequencies may, as has been described in relation to the first aspect, be represented or approximated in a number of manners. Such “post processing” need not be performed initially but may be performed by a future user to either adapt the points in time/second frequencies from one source to the information received relating to other tracks from another source.

Finally, the invention relates to a computer program adapted to control a processor to perform the method according to any of the first and/or second aspects of the invention.

In the following, preferred embodiments will be described with reference to the drawing, wherein:

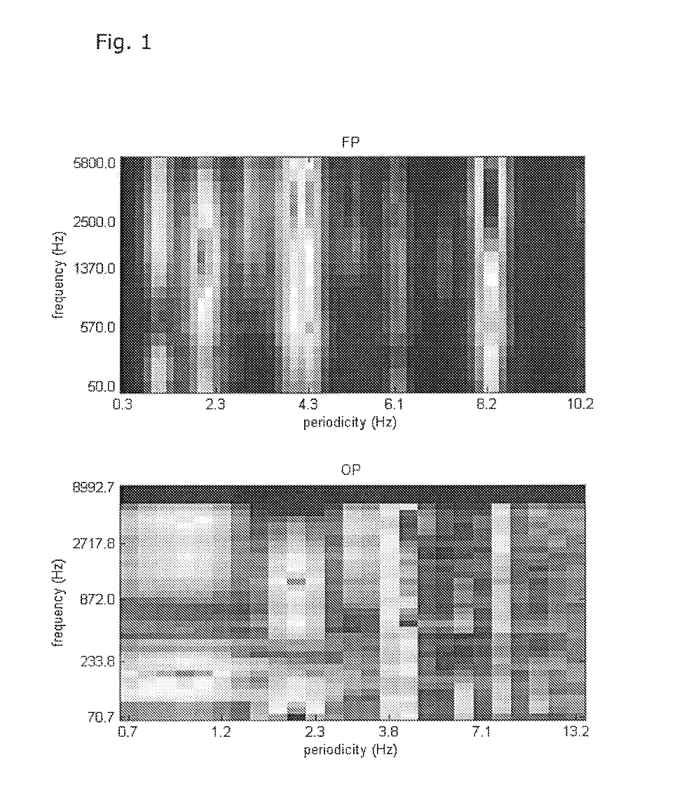

FIG. 1 illustrates FP (calculated by using the MA toolbox) and OP of the same song. Doubling of periodicity appears evenly spaced in the OP. A bass drum plays at regular rate of about 2 Hz. The piece has a tap-along tempo of about 4 Hz, while the measured periodicities at about 8 Hz are likely caused by offbeats in between taps.

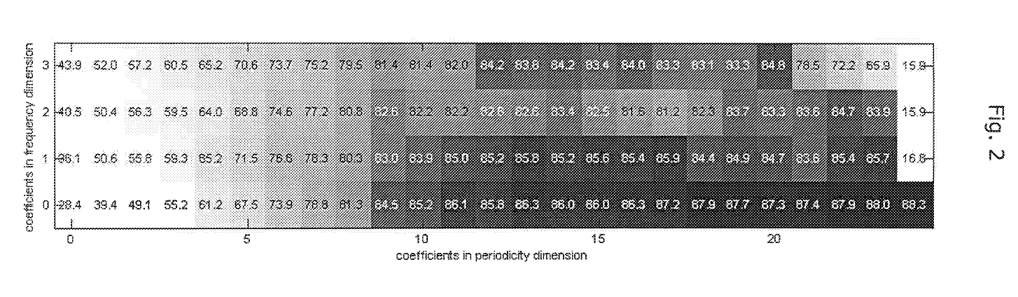

FIG. 2 illustrates dance genre classification based on OnsetCoefficients,

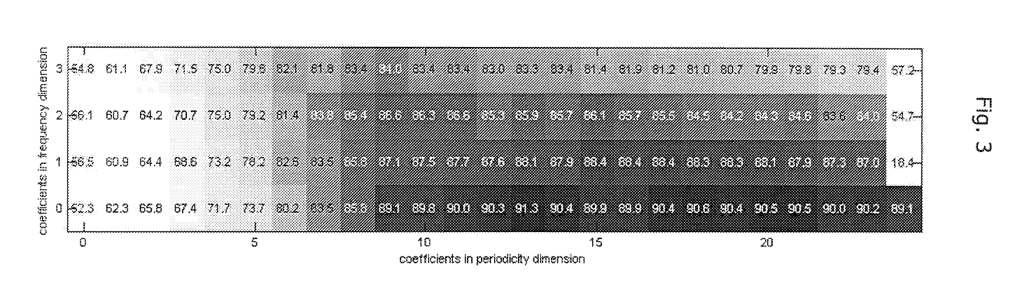

FIG. 3 illustrates a combination of OCs with Umbral component on the ballroom dancers collection, 1NN 10 fold cross validation

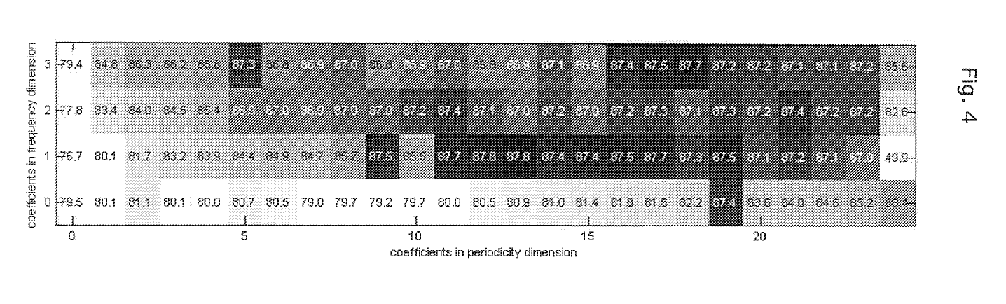

FIG. 4 illustrates a combination of OCs with timbral component, ISMIR'04 training collection.

Based on the notion that in general onsets are of more importance in music perception than e.g., decay phases, only onsets (or increasing amplitude) are considered in a given frequency band. To detect such onsets, a cent-scale representation of the spectrum is used with 85 bands of 103.6 cent width, with frames being 15.5 ms apart. On each of these bands, an unsharp-mask like effect is applied by subtracting from each value the mean of the values over the last 0.25 sec in this frequency band, and half-wave rectifying the result. Subsequently, values are transformed by taking the logarithm, and reducing the number of frequency bands from 85 to 38 (which was chosen empirically).

As in the usual computation of Fluctuation Patterns (FPs), which measure periodicities of the loudness in various frequency bands, segments of frames are analyzed for periodicities. Segments of 2.63 sec length are used with a superimposed Hanning window, zero-padded to six seconds. Adjacent segments are 0.25 sec apart. Each of these segments is analyzed for periodicities in the range from T0=1.5 sec up to about 13.3 Hz (40 to about 800 bpm), separately in each of the 38 frequency bands. An interesting point in this transformation is that periodicities are not represented on a linear scale (as in FPs), but rather as a log-representation. Thus, after taking the FFT on the six seconds of a given frequency band, a log filter bank is applied to represent the selected periodicity range in 25 log-scaled bins. In this representation, periodicity (measured in Hz) is doubled every 5.8 bins (i.e., going 6 bins to the right means measuring a periodicity about twice as fast). By using this log scale, all activations in an OP are shifted by the same amount in the x-direction when two pieces have the same onset structure but different tempi. While this representation is not blurred (as done in the computation of FPs), the applied logarithmic filter bank induces a smearing. After a segment is computed, each of the 25 periodicities is normalized to have the same response to a broadband noise modulated by a sine with the given periodicity. This is done to eliminate the filter effect of the onset detection step and the transformation to logarithmic scale.

To arrive at a description of an entire song, the values over all segments are combined by taking the mean of each value over all segments. This resulting representation of size 38×25 are henceforth called Onset Patterns (OPs). The distance between OPs is calculated by taking the Euclidean distance between the OPs considered as column vectors.

FIG. 1 illustrates FP and OP of the same song. Doubling of periodicity appears evenly spaced in the OP. A bass drum plays at regular rate of about 2 Hz. The piece has a tap-along tempo of about 4 Hz, while the measured periodicities at about 8 Hz are likely caused by offbeats in between taps.

This Onset Patterns representation characterizes the rhythm of a song and may be used directly for determining similarity between tracks. The OPs however, require a large number of values. More compact representations are desired. One such representation is the below “OnsetCoefficients”.

OnsetCoefficients are obtained from all OP segments of a song by applying the two-dimensional discrete cosine transformation (DCT) on each OP segment, and discarding higher-order coefficients in each dimension. The DCT leads to a certain abstraction from the actual tempo (and from the frequency bands). This corresponds to the observation that slightly changing the tempo does not have a big impact on the perceived characteristic of a rhythm, while the same rhythm played with a drastically different tempo may have a very different perceived characteristic. For example, one can imagine that a slow and laid-back drum loop, used in a Drum'n'Bass track played back two or three times as fast, is perceived as cheerful.

The number of DCT coefficients kept in each dimension (periodicity/frequency) is an interesting parameter. The selected coefficients are stacked into a vector. For example, keeping coefficients 0 to 7 in the periodicity dimension, and coefficients 0 to 2 in the frequency dimension yields a vector of length 8×3=24. We abbreviate this selection as 7×2. Based on the vectors for all segments, the mean and full covariance matrix (i.e, a single Gaussian) is calculated, which is the OC feature data for a song.

The OC distance D between two Songs (i.e., Gaussians) X and Y is calculated by the so-called Jensen-Shannon (JS) divergence (cf. Jinhua Lin “Divergence measurements based on the Shannon Entropy”, IEEE Transactions on Information Theory, 37:145-151, 1991).

D(X, Y)=H(M)−(H(X)+H(Y))/2

where H denotes the entropy, and M is the Gaussian resulting from merging X and Y. The merged Gaussian may be calculated as described in Ma, J. and He, Q. A Dynamic Merge-or-Split Learning Algorithm on Gaussian Mixture for Automated Model Selection. Proceedings of 6th International Conference on Intelligent Data Engineering and Automated Learning—IDEAL, p. 203-210, Brisbane, Australia, Jul. 6-8, 2005. We use the square root of this distance.

Setup for Rhythm Experiments

We evaluate the rhythm descriptors on a ballroom dance music (data from ballroomdancers.com) collection. This collection consists of 698 snippets of about 30 seconds length, assigned to 8 different dance music styles (“genres”). The classification baseline is 15.9%.

The purpose of the descriptors discussed above is to measure rhythmic similarity. For evaluation, it is assumed that tracks that are in the same class have a similar rhythm.

A 1NN stratified 10-Fold cross validation (averaged over 32 runs) is used in spite of a certain variance induced by the random selection of folds. It is assumed that the only information that is available is the audio signal. Based on 1NN 10 fold cross validation, 79.6% accuracy has been reported earlier when classification is only based on the audio signal (i.e., when no human-annotated information or corrections are given).

FIG. 2 illustrates dance genre classification based on OnsetCoefficients; distances calculated with the present version of the Jensen-Shannon divergence. 1NN 10 fold CV accuracies obtained on ballroom dataset when including coefficients 0 up to the given number in the respective dimension. For example, including coefficients 0 . . . 17 in the periodicity dimension and coefficients 0 . . . 1 in frequency dimension (resulting in 18×2=36 dimensional feature data) yields an accuracy of 85.9%. Low results at the right border are caused by numerical instabilities when calculating the determinant during entropy computation. For better visibility, gray shades indicate ranks instead of actual values.

Results for Rhythm-Only Descriptors

FPs as implemented in the MA toolbox, compared by Euclidean distance, yield an accuracy of 75.0%. OPs compared with Euclidean distance yield 86.7%. The results for various settings of using only OnsetCoefficients for similarity estimation are shown in FIG. 2. It can be seen that the highest values are obtained when keeping more than 16 coefficients in the periodicity dimension and when only keeping the 0th coefficient in the frequency dimension (which corresponds to averaging over all frequencies). In this range, values increase when including more periodicity coefficients. In this range, an average value of 87.7% is obtained. The average is used rather than the maximum value as an indicator due to variances introduced by 10 fold CV.

Adding “Timbre” Information

To examine how the discussed rhythmic descriptors can be used in conjunction with “bag of frames” audio similarity measures, they are combined with a “timbral” audio similarity measure. The used frame-based features are the well-known MFCCs (coefficients 0 . . . 15), Spectral Contrast Coefficients (Dan-Ning Jiang Jiang, Lie Lu, Hong-Jiang Zhang, Juan-Hua Tao and Lian-Hong Cai, “Music type classification by spectral contrast feature”, In Proceedings of the IEEE International Conference on Multimedia and Expo (ICME), Lausanne (Switzerland), August 2002) using the 2N method (Jean-Julien Aucouturier and Francois Pachet, “Improving timbre similarity: How high is the sky?”, Journal of Negative Results in Speech and Audio Sciences, 1(1), 2004), coefficients 0 . . . 15), and two descriptors “Harmonicness” and “Attackness” that describe the strength of harmonic and percussive components at the current audio frame (Nogutaka Ono, Kenichi Miyamoto, Hirokazu Kameoka and Shigeki Sagayama, “A real-time equalizer for harmonic and percussive components in music signals” in Proc. International Conference on Music Information Retrieval (ISMIR'08), Philadelphia, Pa., USA, Sep. 14-18, 2008). Altogether, these are 34 descriptor values for a frame, which are combined over a song by taking their mean and full covariance matrix. Two songs are compared by taking the Jensen-Shannon divergence as described above.

The discussed rhythm descriptors are combined with this Umbral component by simply summing up the two distance values (i.e., Umbral and rhythm component are weighted 1:1).

To bring the two distances (rhythm based and timbre based) to a comparable magnitude, for each song the distances of this song to all other songs in the collection are normalized by mean removal and division by standard deviation. This is done once before splitting up training and test sets for classification. No class labels are used in this step. Subsequently, the distances are symmetrized by summing up the distances between each pair of songs in both directions. This preprocessing step is done for each component (timbral and rhythm) independently before summing them up.

Combination Experiment

The experiment shown in FIG. 2 is repeated, but this time combining the rhythm descriptors with the Umbral component as described. The 1NN 10 fold cross validation accuracy is 54.0% when considering only the timbral component, 79.4% in combination with FPs, and 87.1% with OPs. From the results in FIG. 3, which illustrates the combination of OCs with Umbral component on the ballroom dancers collection, 1NN 10 fold cross validation, it can be seen that classification results are improved when combining OCs with the timbral component. This time, average results of 90.2% are obtained over the parameter range discussed above (compared to 87.7% in the the first experiment, FIG. 2). The highest obtained 1NN accuracy is 91.3%.

Results are summarized in Table 1, illustrating the ballroom dataset: 10 fold CV accuracies obtained by the evaluated methods. The methods below the line are combined by distance normalization and addition. The results for the combined method are above the values obtained for each component (rhythm and timbre) alone. This may be an indication that rhythm similarity computations can be improved by including timbre information.

TABLE 1

| Algorithm | 1NN |
|---|---|
| Baseline | 15.9% |
| FP | 75.0% |
| OP | 86.7% |
| OC | up to around 87.7% |
| Timbre | 54.0% |
| Timbre + FP | 79.4% |
| Timbre + OP | 87.1% |
| Timbre + OC | up to around 90.2% |

Data Sets

Music similarity experiments are performed on the set from the ISMIR'04 genre classification contest (ISMIR'04) which consists of music from Magnatune.com, and on the “Homburg” data set (HOMBURG) (cf. Helge Homburg, Ingo Mierswa, Bülent Möller, Katharina Morik and Michels Wurst, “A benchmark dataset for audio classification and clustering” in Proc. International Conference on Music Information Retrieval (ISMIR'05), 2005). Like the ballroom set, these collections are available to the research community, which facilitates reproduction of experiments and gives a benchmark for comparing different algorithms. The ISMIR'04 collection comes in two flavours. The first is the “training” set which consists of 729 tracks from six genres. The second consists of all the tracks in the “training” and “development” sets, which are 1458 tracks from six genres. We use the central two minutes from each track. The HOMBURG set consists of 1886 excerpts of 10 seconds length.

Combination Experiment

In this section, a similar experiment is conducted as in the above first “combination experiment” section on the ISMIR'04 training collection. The aim is to evaluate the impact of OCs on the performance in general music similarity computation (i.e., not limited to rhythm similarity). The results from these experiments are used to create a “unified” algorithm, which will then be evaluated on all three collections (including the HOMBURG collection).

Genre classification accuracy is taken as an indicator of the algorithm's ability to find similar sounding music. The same evaluation methodology is used as before. The timbre component alone yields 83.8%. Combining it with FPs as described, accuracy drops to 83.6%. Using OPs instead, accuracy increases to 85.2%. With OCs, accuracy can be improved up to 87.8% in the parameter range shown in FIG. 4 illustrating a combination of OCs with timbral component, ISMIR'04 training collection. Comparing FIGS. 3 and 4, it seems that a good tradeoff between the two collections is found when using 16×1 OCs. This selection yields 17×2=34-dimensional feature data, i.e., the rhythm feature data consists of a mean vector of length 34 and a covariance matrix of size 34²=1156.

Final Evaluation and Optimization

In Table 2, illustrating accuracies obtained by the “unified” algorithm on the various collections, 10 fold CV results obtained with this setting are listed.

TABLE 2

| | | highest kNN |
|---|---|---|
| Collection | 1NN | (maximum over various k) |
| Ballroom | 88.4% | 89.2% |
| ISMIR′04 train | 87.6% | 87.6% |
| ISMIR′04 1458 | 90.4% | 90.4% |
| HOMBURG | 50.8% | 57.0% |

It is seen that that when tuning to the particular collections, high accuracies may be achieved. For these experiments, leave-one-out evaluation was used for two reasons. First, doing 10 fold cross validation (and repeating it several times for averaging) has a clearly longer runtime, as we evaluate a fixed matrix of pairwise distances. Second, in the 10 fold cross validation experiments, a certain variance is seen between repeated experiments. For example, repeating the same experiment 10 times (averaging over 32 runs each time), the difference between lowest and highest 1NN accuracy can be about 0.3 percentage points. We attribute this variance mainly to the creation of folds (albeit stratified).

These non-exhaustive tuning experiments indicate that even the normalization step used to combine two measures (the first combination experiment section) alone in some cases increases accuracy. On the Ballroom Dancers collection, a 3NN accuracy of 91.8% is obtained when including normalised OCs up to 24×0. Using only the normalised timbre component, on the ISMIR'04 training set a 1NN accuracy of 88.8%, and on the full ISMIR'04 set an accuracy of 91.8% is reached. On the HOMBURG set, 11NN classification using only the normalised timbre component yields 58.4%.

1. A method of deriving information from an audio track, the method comprising the steps of:
1. for each of a plurality of first frequencies or frequency bands, deriving from the track information relating to points in time, or one or more second frequencies, of occurrence of intensity/amplitude variations exceeding a predetermined value/percentage in the actual first frequency/band,
2. deriving the information relating to the track from the first frequencies/bands and the one or more points in time and/or one or more of the second frequencies relating to the first frequencies/bands
wherein step 2 comprises representing the information as an at least one-dimensional representation along at least one axis, the points in time or second frequencies being represented along one of the axes on a non-linear scale.

2. (canceled)

3. A method according to claim 1, wherein step 1 comprises removing, in each first frequency/band, parts of the track not having an intensity/amplitude variation exceeding the predetermined value/percentage.

4. (canceled)

5. (canceled)

6. A method according to claim 1, wherein step 2. comprises deriving the representation of the information as an at least two-dimensional representation having along a second axis the first frequencies/bands.

7. A method according to claim 1, wherein step 2. comprises the steps of:
applying/fitting an at least one-dimensional curve/transformation to the representation of the derived information in a coordinate system having a second axis of the coordinate system relating to a strength of the second frequencies or of the intensity/amplitude variations at the pertaining points in time and
deriving the information as parameters of the applied/fitted curve/transformation.

8. (canceled)

9. A method of estimating a similarity between a first and a second audio track, the method comprising the steps of:
deriving, from each track, information as derived by the method according to claim 1,
performing a determination of the similarity from a similarity between the derived information.

10. A method according to claim 9, wherein the determination step comprises determining a Kullback-Leibler divergence between the information derived from the first and second audio tracks.

11. (canceled)

12. An apparatus for deriving information from an audio track, the apparatus comprising:
first means for, for each of a plurality of first frequencies or frequency bands, deriving from the track information relating to points in time or one or more second frequencies of occurrence of intensity/amplitude variations exceeding a predetermined value/percentage in the actual first frequency/band,
second means for deriving the information relating to the track from the first frequencies/bands and the one or more points in time and/or one or more of the second frequencies relating to the first frequencies/bands,
wherein the second means are adapted to derive a representation of the information in an at least one-dimensional representation having along one axis the points in time or second frequencies on a non-linear scale.

13. (canceled)

14. An apparatus according to claim 12, wherein the first means are adapted to remove, in each first frequency/band, parts of the track not having an intensity/amplitude variation exceeding the predetermined value/percentage.

15. An apparatus according to claim 12, wherein the first means are adapted to determine the one or more second frequencies by Fourier transforming a part of the track within the first frequency/band.

16. (canceled)

17. (canceled)

18. An apparatus according to claim 12, wherein the second means is adapted to:
apply/fit an at least one-dimensional curve/transformation to the representation of the derived information in a coordinate system having a second axis of the coordinate system relating to a periodicity of the second frequency or of the intensity/amplitude variations at the pertaining points in time and
derive the information as parameters of the applied/fitted curve/transformation.

19. (canceled)

20. An apparatus for estimating a similarity between a first and a second audio track, the apparatus comprising:
an apparatus according to claim 12 for deriving, from each track, derived information,
means for receiving the derived information and for performing a determination of the similarity from a similarity between the derived information.

21. An apparatus for estimating a similarity between a first and a second audio track, the apparatus comprising:
means for accessing information derived according to the method of claim 1, for each track,
means for receiving the derived information and for performing a determination of the similarity from a similarity between the derived information.

22. An apparatus according to claim 12, wherein the second means is adapted to determine a Kullback-Leibler divergence between the information derived from the first and second audio tracks.

23. An apparatus according to claim 12, wherein the second means is adapted to represent the derived information as vectors and determine the similarity from a distance between the vectors.

24. A data storage comprising a plurality of groups of information each group of information relating to an audio track and to one or more second frequencies of amplitude/intensity variations exceeding a predetermined value/percentage within one or more first frequencies/frequency bands of the pertaining audio track, the information being represented as an at least one-dimensional representation along at least one axis, the points in time or second frequencies being represented along one of the axes on a non-linear scale.

25. A computer program adapted to control a processor to perform the method according to claim 1.
